(19) United States
(12) Patent Application Publication
(10) Pub. No.: US 2018/0361891 A1
(43) Pub. Date: Dec. 20, 2018

(54) VEHICLE AIR CONDITIONING STRUCTURE

(71) Applicant: TOYOTA BOSHOKU KABUSHIKI KAISHA, Aichi-ken (JP)

(72) Inventors: Yasuhiro KATO, Aichi-ken (JP); Fumitoshi AKAIKE, Aichi-ken (JP); Kohei NAKAMURA, Aichi-ken (JP)

(73) Assignee: TOYOTA BOSHOKU KABUSHIKI KAISHA, Aichi-ken (JP)

(21) Appl. No.: 16/010,873

(22) Filed: Jun. 18, 2018

(30) Foreign Application Priority Data
Jun. 19, 2017 (JP) 2017-119374

(51) Int. Cl. B60N 2/56; B60H 1/00

(52) U.S. Cl. CPC B60N 2/5628; B60H 1/00285; B60N 2/5657

(57) ABSTRACT

A vehicle air conditioning structure including: a pair of air outlets which is provided at both side regions of a vehicle seat in a seat width direction and is configured to blow air toward an inner side in the seat width direction, wherein the pair of air outlets is arranged so as to blow the air obliquely in directions intersecting with the seat width direction such that the air blown from the air outlets hit each other in the seat width direction, thereby directing the hit air toward a specific body part of a seated person on the vehicle seat.

### CROSS-REFERENCE TO RELATED APPLICATIONS

This application claims priority from Japanese Patent Application No. 2017-119374 filed on Jun. 19, 2017, the entire contents of which are incorporated herein by reference.

### TECHNICAL FIELD

The disclosure relates to a vehicle air conditioning structure. More particularly, the disclosure relates to a vehicle air conditioning structure including an air outlet which is configured to blow air toward a seated person on a vehicle seat.

### BACKGROUND

A related-art vehicle air conditioning system is configured such that a first air outlet which blows air from a front side toward an upper body of a seated person is set on an instrument panel of a vehicle and a second air outlet which blows air from a rear side toward the air blown from the first air outlet so as to hit the air blown from the first air outlet is set on a ceiling of the vehicle (JP-A-2014-125165). By the hit of the air, a soft air flow diffusing around a seated person is formed such that comfortable air is blown to the seated person.

In the above related art, since a part of the air hitting each other diffuses in a direction which does not blow toward the seated person, it is difficult to efficiently blow air toward the seated person.

### SUMMARY

The disclosure provides a vehicle air conditioning structure capable of efficiently blowing air toward a part of a body of a seated person which is deviated from a blowing-out direction of an air outlet.

According to an aspect of the disclosure, there is provided a vehicle air conditioning structure including: a pair of air outlets which is provided at both side regions of a vehicle seat in a seat width direction and is configured to blow air toward an inner side in the seat width direction, wherein the pair of air outlets is arranged so as to blow the air obliquely in directions intersecting with the seat width direction such that the air blown from the air outlets hit each other in the seat width direction, thereby directing the hit air toward a specific body part of a seated person on the vehicle seat.

Accordingly, the air blown from the pair of air outlets obliquely in the directions intersecting with the seat width direction is made to hit each other in the seat width direction, so that a direction of the air hitting each other can be changed so as to be further bent in an oblique direction. Therefore, even if the body part of the seated person toward whom the above air is to be blown is in a difficult-to-reach position which is deviated from the blowing-out direction of the pair of air outlets, it is possible to efficiently blow the air by a configuration in which the direction of the above air is changed by the hit.

### BRIEF DESCRIPTION OF DRAWINGS

FIG. 1 is a perspective view showing a schematic configuration of an air conditioning structure according to Embodiment 1;

FIG. 2 is a plan view of FIG. 1;

FIG. 3 is a front view of FIG. 1; and

FIG. 4 is a side view of FIG. 1.

### DETAILED DESCRIPTION

Hereinafter, embodiments for implementing the disclosure will be described with reference to the drawings.

### Embodiment 1

<Schematic Configuration of Air Conditioning Structure 1A>

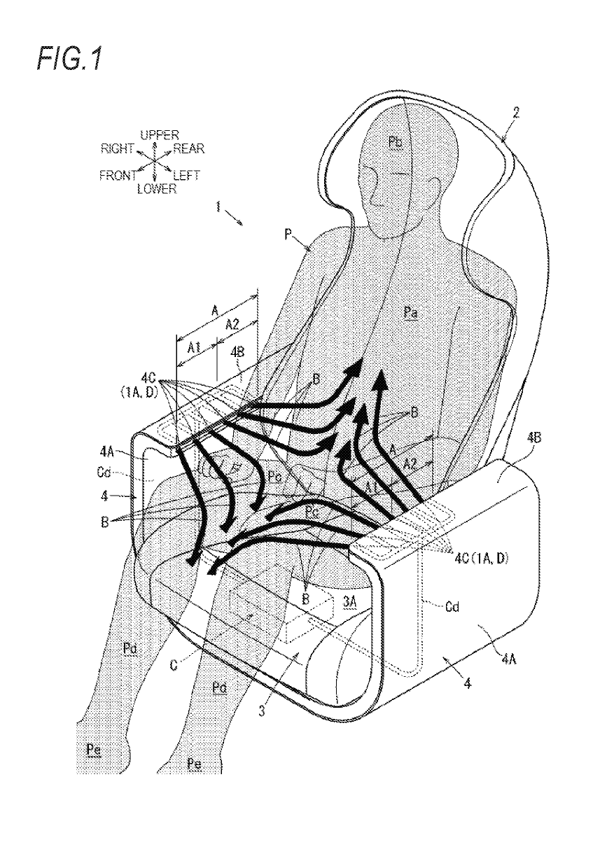

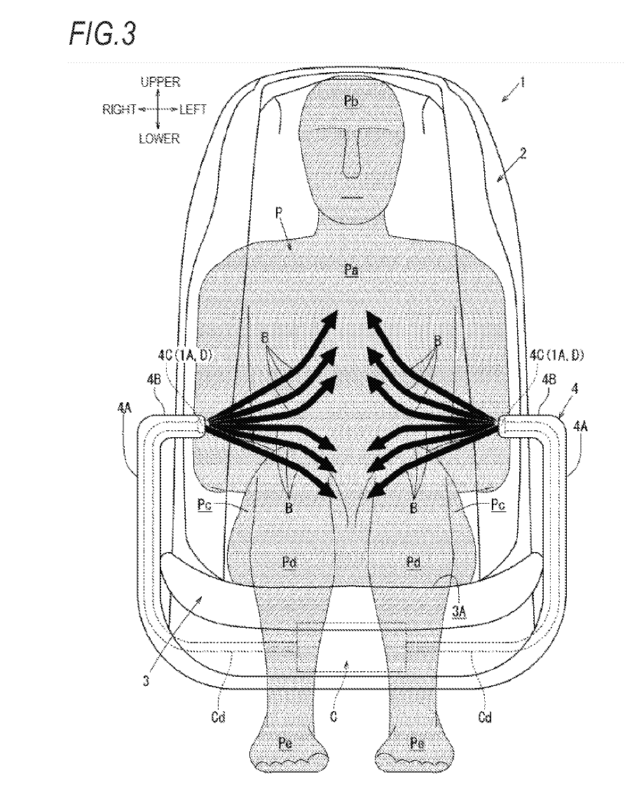

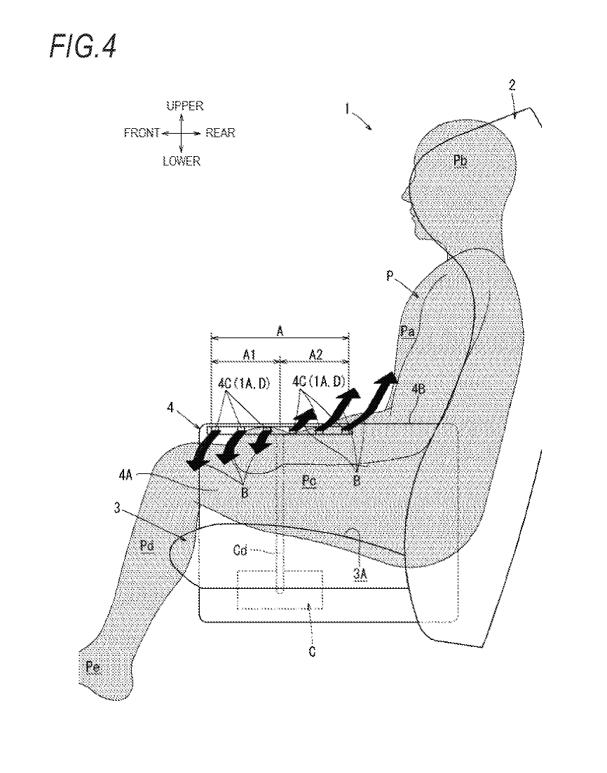

First, a configuration of an air conditioning structure 1A (vehicle air conditioning structure) according to Embodiment 1 will be described with reference to FIGS. 1 to 4. In the following description, directions such as front, rear, upper, lower, left and right refer to directions shown in each drawing respectively. Also, a “seat width direction” refers to a left-right direction of a seat 1 (vehicle seat) described later, a “seat height direction” refers to an upper-lower direction of the seat 1, and a “seat front-rear direction” refers to a front-rear direction of the seat 1.

The air conditioning structure 1 A of the present embodiment is applied to the seat 1 which is provided as a rear seat of an automobile. The seat 1 includes a seat back 2 serving as a backrest part of a seated person P, a seat cushion 3 serving as a seating part, and a pair of left and right armrests 4 serving as elbow rests.

Lower end parts on left and right sides of the seat back 2 are coupled to rear end portions on left and right sides of the seat cushion 3 respectively via a recliner (not shown) in a state where a backrest angle can be adjusted. A bottom surface part of the seat cushion 3 is coupled to a floor of the vehicle via a pair of left and right slide rails (not shown) in a state where the positions in a seat front-rear direction can be adjusted.

<Configuration of Armrests 4>

The pair of left and right armrests 4 is coupled to the side portions on the left and right sides of the seat cushion 3 respectively and provided at a shape having a top plate surface serving as an elbow rest at a high position rising from these side portions. Specifically, each of the pair of left and right armrests 4 includes a rising plate portion 4A which rises up from a side portion of the left and right sides of the seat cushion 3 in a shape with its surface facing a seat width direction, and a top plate portion 4B which projects in an eaves shape from an upper edge portion of the rising plate portion 4A to an inner side in the seat width direction and includes a top plate surface which forms an elbow rest on the upper surface side. Here, the top plate portion 4B of each of the armrests 4 corresponds to a “vehicle interior member” and a “structural member of the armrest” of the disclosure.

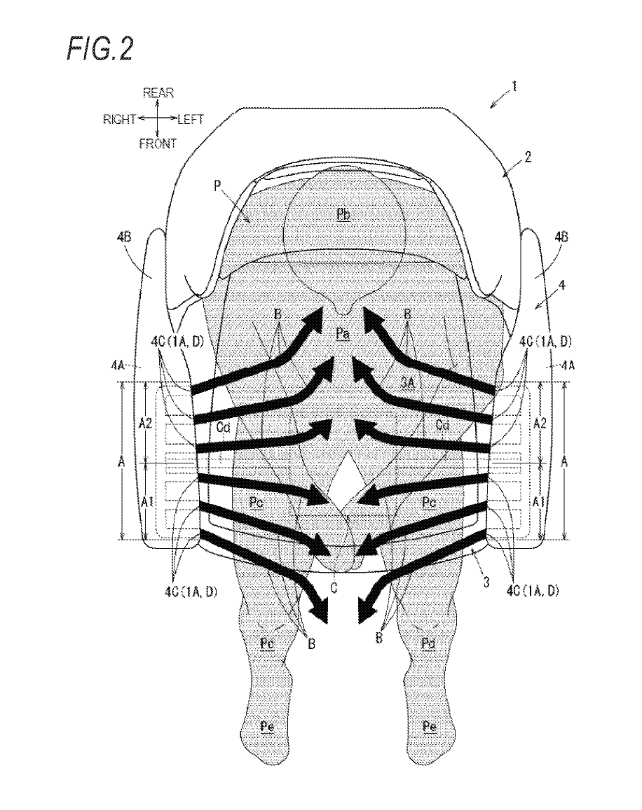

As shown in FIG. 2, each top plate portion 4B has a shape which projects from an upper edge portion of the rising plate portion 4A to the inner side in the seat width direction, such that the arrangement thereof in the seat width direction is overlapped with a seating surface region 3A on the left and right sides of the seat cushion 3. Each top plate portion 4B is arranged such that each top plate portion 4B has substantially the same length with the seating surface region 3A on the left and right sides of the seat cushion 3 in the seat front-rear direction, and the arrangement thereof in the seat front-rear direction is also overlapped with the seating surface region 3A on the left and right sides of the seat cushion 3 over a substantially whole region.

<Configuration of Air Outlets 4C>

As shown in FIG. 1, on edge portions which are tips of the top plate portions 4B projecting inward in the seat width direction, air outlets 4C which open toward the inner side in the seat width direction are formed at a plurality of positions in the seat front-rear direction along these edge portions. These air outlets 4C are respectively in flow path connection with an air conditioning unit C installed in a lower portion of the seat cushion 3 through a duct Cd which is arranged to pass through the inside of the armrest 4 on each side. Each of the air outlets 4C is configured such that air B sent out from the air conditioning unit C can be blown to the inner side in the seat width direction toward the body of the seated person P through the above flow path connection.

Each of the air outlets 4C on the left and right sides formed in the armrests 4 is formed in an overhanging region (forming region A) projecting further frontward than a body part Pa of the seated person P on the armrest 4 on each side. Specifically, as shown in FIGS. 1 to 4, in each of the air outlets 4C, an opening direction which is a direction of blowing the air B is not straight along the inner side in the seat width direction, but is set to a direction inclined obliquely in the seat height direction or the seat front-rear direction, which is a direction intersecting with the seat width direction.

Specifically, among the air outlets 4C, the air outlets 4C arranged in front side regions A1, which are the front sides from substantially a center position in the seat front-rear direction of forming regions A, are bilaterally symmetrical and set to an opening direction in which the air B is blown toward the inner side in the seat width direction and obliquely downward. Further, the air outlets 4C arranged in rear side regions A2, which are the rear sides from substantially the center position in the seat front-rear direction of the forming regions A, are bilaterally symmetrical and set to an opening direction in which the air B is blown toward the inner side in the seat width direction and obliquely upward.

<Air B from Front Side Region A1>

More specifically, as from the rear side (substantially a center portion side in the seat front-rear direction in each formation region A) to the front side, the directions of the air B blown from the air outlets 4C on the left and right sides arranged in the front side regions A1 of the armrests 4 are set to a gradually changing angular direction which gradually becomes forward and further downward from a substantially lateral angle which faces the inner side in the seat width direction substantially straight at a slightly downward angle. Specifically, the downward angle of each of the air outlets 4C is set to a direction of blowing the air B to a position higher than the body part such as a thigh part Pc, a lower leg part Pd, and a foot part Pe of the seated person P serving as a target to which the air B is blown.

However, even if each of the air outlets 4C is set to the above direction, the air B blown from the air outlets 4C arranged in the front side regions A1 of the armrests 4 can appropriately be blown to wide body parts such as the thigh part Pc, the lower leg part Pd and the foot part Pe of the seated person P lower than these air outlets 4C as follows. In the following description, it is assumed that the strength of the air B blown from the air outlets 4c on the left and right sides is set to the same strength on the left and right sides. Here, the thigh part Pc, the lower leg part Pd and the foot part Pe of the seated person P correspond to “specific body parts” of the disclosure.

That is, the air B blown from the air outlets 4C on the left and right sides arranged in the front side regions A1 of the armrests 4 hits each other in the seat width direction at a center in the seat width direction of the seating surface region 3A of the seat cushion 3 and at a position higher than the thigh part Pc of the seated person P. Accordingly, the air B from the left and right sides hits each other and diffuses to the periphery and the directions of the air B hitting each other are mainly bent downward which is the resultant force direction, such that the air B can be blown from the upper side to the thigh part Pc of the seated person P widely as indirect air.

Further, the air B blown from the air outlets 4C on the left and right sides arranged in the front side regions A1 of the armrests 4 gradually blows forward as going from the rear side to the front side and is changed further downward, so that the air B hits each other in the seat width direction at the center in the seat width direction further frontward than the seat cushion 3 and at a position further frontward than the lower leg part Pd of the seated person P. Accordingly, the air B from the left and right sides hits each other and diffuses to the periphery and the directions of the air B hitting each other are mainly bent frontward and downward which is the resultant force direction, such that the air B can be blown from the front side to the lower leg part Pd of the seated person P and from the upper side to the foot part Pe of the seated person P widely as indirect air.

At that time, since the air B blown from the air outlets 4C on the left and right sides hits each other in the seat width direction and diffuses, a force that pushes the air B flowing in the seat width direction at the front lower side from a rear upper side to the front lower side is applied by the action of the diffused air. By the above action, the blown air B can flow to the front side and the lower side with the angle significantly changed even if the direction of each of the air outlets 4C is not significantly forward or downward.

<Air B from Rear Side Region A2>

Further, as from the front side (substantially the center portion side in the seat front-rear direction in each formation region A) to the rear side, the directions of the air B blown from the air outlets 4C on the left and right sides arranged in the rear side regions A2 of the armrests 4 are set to a gradually changing angular direction from a substantially lateral angle which faces the inner side in the seat width direction substantially straight at a slightly upward angle to the rearward angle and further upward angle gradually. Specifically, the rearward angle of each of the air outlets 4C is set to a direction of blowing air B to a position further frontward than the body part such as the body part Pa, the head part Pb of the seated person P serving as a target to which the air B is blown.

However, even if each of the air outlets 4C is set to the above direction, the air B blown from the air outlets 4C arranged in the rear side regions A2 of the armrests 4 can appropriately be blown to wide body parts such as the body part Pa and the head part Pb of the seated person P located further rearward than these air outlets 4C as follows. In the following description, it is assumed that the strength of the air B blown from the air outlets 4C on the left and right sides is set to the same strength on the left and right sides. Here, the body part Pa and the head part Pb of the seated person P correspond to the “specific body parts” of the disclosure.

That is, the air B blown from the air outlets 4C on the left and right sides arranged in the rear side regions A2 of the armrests 4 hits each other in the seat width direction at the center in the seat width direction of the seating surface region 3A of the seat cushion 3 and at a position further frontward than the body part Pa of the seated person P. Accordingly, the air B from the left and right sides hits each other and diffuses to the periphery and the directions of the air B hitting each other are mainly bent rearward which is the resultant force direction, such that the air B can be blown from the front side to the body part Pa of the seated person P widely as indirect air.

Further, the air B blown from the air outlets 4C on the left and right sides arranged in the rear side regions A2 of the armrests 4 gradually blows rearward as going from the front side to the rear side and is changed further upward, so that the air B hits each other in the seat width direction at the center in the seat width direction further rearward and upward than the air outlets 4C and at a position further frontward than the body part Pa of the seated person P. Accordingly, the air B from the left and right sides hits each other and diffuses to the periphery and the directions of the air B hitting each other are mainly bent rearward and frontward which is the resultant force direction, such that the air B can be blown from the front side to the body part Pa of the seated person P and from the front lower side to the head part Pb of the seated person P widely as indirect air.

At that time, since the air B blown from the air outlets 4C on the left and right sides hits each other in the seat width direction and diffuses, a force that pushes the air B flowing in the seat width direction at the rear upper side from the front lower side to the rear upper side is applied by the action of the diffused air. By the above action, the blown air B can flow to the rear side and the upper side with the angle significantly changed even if the direction of each of the air outlets 4C is not significantly rearward or upward.

Therefore, for example, in winter, by making the air B blown from each of the front side regions A1 warmer than the air B blown from each of the rear side regions A2 and increasing the air volume, it is possible to blow comfortable air conditioning air to the seated person P. Further, in summer, by making the air B blown from each of the rear side regions A2 colder than the air B blown from each of the front side regions A1 and increasing the air volume, it is possible to blow comfortable air conditioning air to the seated person P. Here, the air outlets 4C may be switched such that only the front side regions A1 or the rear side regions A2 blow the air B.

The seated person P as a target in the present embodiment is assumed to have a large body size such as AM 95. Therefore, even if the seated person P having a smaller body size is seated, the above air conditioning air can be appropriately blown toward the seated person P.

Further, for the armrest 4 on each side, the air outlets 4C are arranged via an angle adjusting mechanism D by which a blowing-off angle in the seat front-rear direction and the blowing-off angle in the seat height direction can be adjusted freely and individually. By the angle adjusting mechanism D, the blowing-out angle of each of the air outlets 4C can be freely adjusted according to the body size of the seated person P and the purpose of use, and more comfortable air conditioning air can be blown to the seated person P. Although the above angle adjusting mechanism D may be configured such that the blowing-out angle of each of the air outlets 4C can be adjusted by a direct manual operation or an indirect operation using a lever or the like, the blowing-out angle may be adjusted by a desired switch operation or an electric operation which uses signal detection for detecting posture change or position change of the seat 1, or the like.

<Summary>

In summary, the air conditioning structure of the embodiment has the following configuration. That is, the vehicle air conditioning structure (1A) includes the pair of air outlets (4C) which is provided at both side regions of the vehicle seat (1) in the seat width direction and is configured to blow the air (B) toward the inner side in the seat width direction, wherein the pair of air outlets (4C) is arranged so as to blow the air (B) obliquely in the directions (the seat height direction or the seat front-rear direction) intersecting with the seat width direction such that the air (B) blown from the air outlets hit each other in the seat width direction, thereby directing the hit air toward the specific body parts (Pa, Pb, Pc, Pd and Pe) of the seated person (P) of the vehicle seat (1).

In this way, the air (B) blown from the pair of air outlets (4C) obliquely in the directions intersecting with the seat width direction (seat height direction or seat front-rear direction) is made to hit each other in the seat width direction, so that the direction of the air (B) hitting each other can be changed so as to be further bent in an oblique direction. Therefore, even if the body parts (Pa, Pb, Pc, Pd and Pe) of the seated person (P) to whom the above air (B) is to be blown are in difficult-to-reach positions which are deviated from the blowing-out direction of the pair of air outlets (4C), it is possible to efficiently blow the above air (B) by the configuration in which the direction of the air (B) is changed by the hit.

Further, the pair of air outlets (4C) is provided to the vehicle interior members (4B) which are provided at the both side regions of the vehicle seat (1) located at a front side of the seat back (2). With such a configuration, the pair of air outlets (4C) can be set to suitable positions for blowing the air (B) obliquely in the direction (the seat height direction or the seat front-rear direction) intersecting with the seat width direction toward various body parts (Pa, Pb, Pc, Pd and Pe) of the seated person (P).

Further, the vehicle interior members (4B) provided with the pair of air outlets (4C) are members (4B) of the armrests (4) provided at the both side regions of the vehicle seat (1). With such a configuration, the pair of air outlets (4C) can be set to a suitable position for blowing air (B) obliquely toward the various body parts (Pa, Pb, Pc, Pd and Pe) of the seated person (P) by using the members (4B) of the armrests (4) provided at both side regions of the vehicle seat (1).

Further, the pair of air outlets (4C) respectively includes the plurality of air outlets (4C) which are arranged alongside each other in the seat front-rear direction and are provided at the both side regions of the vehicle seat (1), the both side regions of the vehicle seat (1) being located at an upper side of the seat cushion (3) and overlapping with the seat cushion (3) in the seat front-rear direction, and the direction of the air (B) blown out from each air outlet provided at the front side region (A1), among the plurality of air outlets (4C) of the pair of air outlets (4C), is directed obliquely downward, and the direction of the air (B) blown out from each air outlet provided at the rear side region (A2), among the plurality of air outlets (4C) of the pair of air outlets (4C), is directed obliquely upward.

With such a configuration, among the plurality of air outlets (4C) of the pair of air outlets (4C), which are arranged alongside each other in the seat front-rear direction and are provided at the both side regions of the vehicle seat (1), by the oblique downward air (B) blown from the pair on both sides provided at the front side region (A1), it is possible to efficiently blow the air (B) from the pair to the thigh part (Pc), the lower leg part (Pd) and the foot part (Pe) of the seated person (P) which are spaced from the pair at the lower side. Further, by the oblique upper directed air (B) blown from the pair on both sides provided at the rear side region (A2), it is possible to efficiently blow the air (B) from these pair to the body part (Pa), the head part (Pb) of the seated person (P) which are spaced from the pair at the upper side.

Further, the directions of the air (B) blown out from the pair of outlets (4C) are capable of being adjusted within directions interesting with the seat width direction (the seat height direction or the seat front-rear direction) (angle adjustment mechanism (D)). With such a configuration, since the air (B) from the pair of air outlets (4C) provided at specific positions is efficiently blown toward the various body parts (Pa, Pb, Pc, Pd and Pe) of the seated person (P), it is possible to adjust the blowing-out direction.

Further, the directions of the air (B) blown out from the pair of air outlets (4C) are set by opening directions of the pair of air outlets (4C).

Further, the pair of air outlets (4C) are arranged bilaterally symmetrically.

### Other Embodiments

As mentioned above, although the embodiment of the disclosure has been described by using one embodiment, the disclosure can be implemented in various forms other than the above embodiment. For example, the vehicle air conditioning structure of the disclosure can be applied to air conditioning structures provided for various vehicles including vehicles other than automobiles such as railroads, aircrafts, ships and the like.

In addition to the structural members of armrests provided at both side regions of the vehicle seat, each pair of air outlets can be provided at other members in the seat structure and other vehicle interior members provided at both side regions further frontward than the seat back of the vehicle seat such as a door trim, a seat structure of an adjacent seat, a center console provided between adjacent seats or the like. Further, the armrest may be provided at a shape extending in a standing plate shape from the seat cushion as shown in the above embodiment, or may be provided at a shape extending forward from the seat back.

Further, the air blown from the pair of air outlets may be different in temperature, humidity, or intensity, and as long as the air is hit with each other in the seat width direction, it may be blown in a direction not symmetrical to each other. In the above embodiment, although the opening shape and the size of each of the pair of air outlets are not particularly described, the opening shape and the size of each of the pair of air outlets are not limited to specific ones, and appropriate opening shapes and sizes can be applied. Further, the pair of air outlets may be provided side by side in a specific direction, or may have a long opening shape extending in a specific direction continuously.

What is claimed is:

1. A vehicle air conditioning structure comprising:
a pair of air outlets which is provided at both side regions of a vehicle seat in a seat width direction and is configured to blow air toward an inner side in the seat width direction,
wherein the pair of air outlets is arranged so as to blow the air obliquely in directions intersecting with the seat width direction such that the air blown from the air outlets hit each other in the seat width direction, thereby directing the hit air toward a specific body part of a seated person on the vehicle seat.

2. The vehicle air conditioning structure according to claim 1,
wherein the pair of air outlets is provided to vehicle interior members which are provided at the both side regions of the vehicle seat located at a front side a seat back.

3. The vehicle air conditioning structure according to claim 2,
wherein the vehicle interior members provided with the pair of air outlets are members of armrests provided at the both side regions of the vehicle seat.

4. The vehicle air conditioning structure according to claim 2,
wherein the pair of air outlets respectively includes a plurality of air outlets which are arranged alongside each other in a seat front-rear direction and are provided at the both side regions of the vehicle seat, the both side regions of the vehicle seat being located at an upper side of a seat cushion and overlapping with the seat cushion in the seat front-rear direction, and
wherein a direction of air blown out from each air outlet provided at a front side region, among the plurality of air outlets of the pair of air outlets, is directed obliquely downward, and a direction of air blown out from each air outlet provided at a rear side region at a rear side of the front side region, among the plurality of air outlets of the pair of air outlets, is directed obliquely upward.

5. The vehicle air conditioning structure according to claim 1,
wherein the directions of the air blown out from the pair of air outlets are capable of being adjusted within directions intersecting with the seat width direction.

6. The vehicle air conditioning structure according to claim 1,
wherein the directions of the air blown out from the pair of air outlets are set by opening directions of the pair of air outlets.

7. The vehicle air conditioning structure according to claim 1,
wherein the pair of air outlets are arranged bilaterally symmetrically.
